(19) United States
(12) Patent Application Publication
(10) Pub. No.: US 2015/0025955 A1
(43) Pub. Date: Jan. 22, 2015

(54) SYSTEM FOR ENROLLMENT OF CUSTOMERS INTO COMPANY LOYALTY PROGRAMS

(71) Applicant: Anthony Douglas deLeon, Ramona, CA (US)

(72) Inventor: Anthony Douglas deLeon, Ramona, CA (US)

(21) Appl. No.: 13/943,519

(22) Filed: Jul. 16, 2013

(51) Int. Cl. G06Q 30/02

(52) U.S. Cl. CPC G06Q 30/0226
USPC 705/14.27

(57) ABSTRACT

Enrollment into a customer loyalty program may be performed on the spot by using a mobile computing device and a software application that receives a person's information and generates a membership account. The information may be extracted from, for example, a driver's license and the software application may associate the information with the member and may issue a membership card to the person without the person having to leave their present location.

### BACKGROUND OF THE INVENTION

The present invention generally relates to hospitality services, and more particularly, a system for enrollment of customers into company loyalty programs.

Customer loyalty programs may be beneficial in encouraging consumers to frequent a company's business. However, customers may be reluctant to sign up for a customer loyalty program because the process typically requires the customer to fill out a membership card application. The customer may not want to spend time filling out an application because they may be in a hurry or are pre-occupied with what they consider more important matter. For example, some casinos offer loyalty programs for players. The player may receive credit for the amount of money wagered and the time spent at any one gaming station. To sign up for a player loyalty program, the person conventionally approaches a concierge desk where an account is created by filling out an application and waiting for the membership account to be approved. In some instances, the person must stand in line waiting for other people to sign up. The priority of the player may be to gamble rather than wait in line and some people may opt to put off signing up in lieu of going directly to the gaming area.

As can be seen, there is a need for facilitating enrollment into a customer loyalty program by enrolling a person on the spot.

### SUMMARY OF THE INVENTION

In one aspect of the present invention, a computer program product for enrolling customers into a company loyalty program comprises a non-transitory computer readable storage medium having program code. The program code may be readable/executable by a processing unit to receive in a mobile computing device, a person's identification information from a driver's license and create, by the processing unit, a member account in the company loyalty program including the received information.

In another aspect of the present invention, a system for enrolling a person into a company loyalty program comprises a server; data storage in the server including member accounts in the customer loyalty program; and a mobile computing device configured to: receive identification information from a driver's license, determine whether the person is a member of the customer loyalty program based on the received identification information, and print out a membership card at a printer, the membership card indicating the person is a member of the customer loyalty program.

These and other features, aspects and advantages of the present invention will become better understood with reference to the following drawings, description and claims.

### BRIEF DESCRIPTION OF THE DRAWINGS

FIG. 1 is a block diagram of a system of enrolling customers into a company loyalty program according to one exemplary embodiment of the present invention;

FIG. 2 is a block diagram of a general computing devices that may be used be computing devices in the system of FIG. 1;

FIG. 3A is a front view of a mobile computing device that may be used in the system of FIG. 1;

FIG. 3B is a top end view of the device of FIG. 3A;

FIG. 3C is a side view of the device of FIG. 3A;

FIG. 3D is a rear view of the device of FIG. 3A with a card partially slid through a card reader installed onto the device; and

FIG. 4 is a flowchart of a method of enrolling customers into a company loyalty program according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system for enrolling customers into a company loyalty program that allow a company representative to approach a person and sign the person up on the spot rather than requiring the person to approach a customer representative at a concierge desk. For example, in a casino setting, a customer loyalty program representative may approach a casino player on the gaming floor and inquire whether the player is a member of the casino's player loyalty program. The customer representative may use a mobile computing device to register the player at, for example, a slot machine or at a gaming table allowing the player to continue gaming while expediently enrolling the player. This may be beneficial to both the player and the casino. The player may begin accumulating credit for gaming without having to stand in line at a remote concierge desk. The casino may acquire more loyalty program members who may otherwise not seek out membership or would otherwise interrupt their gaming to go stand in line and register for membership.

In the description that follows, a “mobile computing device” will be understood to mean that the device is wireless or otherwise not hardwired into a wall socket. Exemplary embodiments of the present invention may be in the form of hardware or software. For example, exemplary embodiments may be in the form of general computers as described below or as processing units performing actions in the computers. Some exemplary embodiments may be in the form of computer program products comprising a non-transitory computer readable storage medium having program code. The program code may be readable and/or executable by, for example, a processing unit to perform actions according to the description that follows.

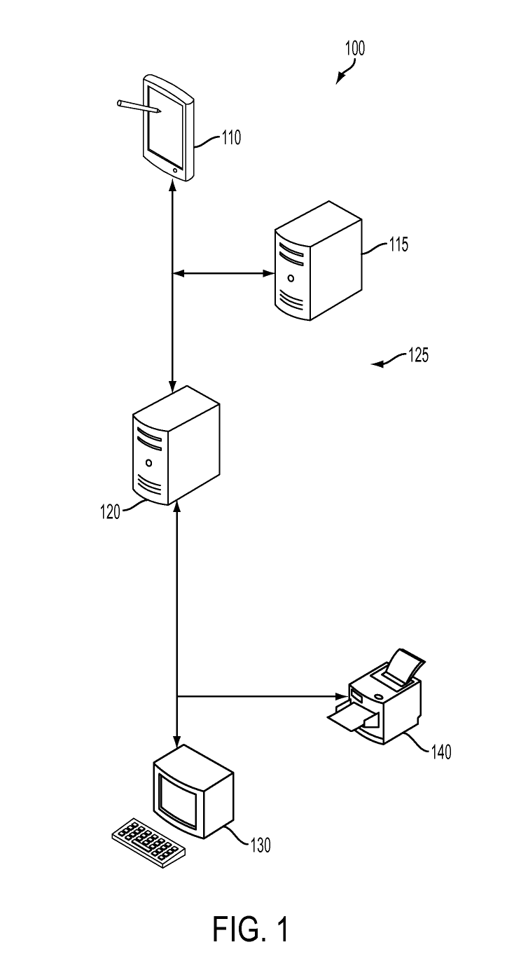

Referring now to FIG. 1, a system 100 for enrolling a person into a company loyalty program. The system 100 may include a mobile computing device 110. The mobile computing device 110 may be for example, a mobile smartphone, a tablet device, or other computing device that can be carried by an individual with nominal effort. The mobile computing device 110 may communicate wirelessly to a middleware server 115 and a gaming server 120. The middleware server 115 may house a webserver where information transmitted by the mobile computing device 110 may be translated and mapped to a company's loyalty program. The middleware server 115 may typically be offsite from the company and may serve more than one company or more than one locale. The gaming server 120 may store the translated data corresponding to information extracted by the mobile computing device 110 and stored into the customer loyalty program. In some embodiments, the server 120 may be on the same premises (not shown) as the mobile computing device 110 or may be offsite and in communication with the mobile computing device 110 through a network 125. In some embodiments, the system 100 may include a computing terminal 130 that may be hardwired into the premises. The computing terminal 130 may be in communication with the mobile computing device 110 and the server 120. In some embodiments, a peripheral device 140, for example, a printer may be in communication with the mobile computing device 110, the server 120, and the computing terminal 130.

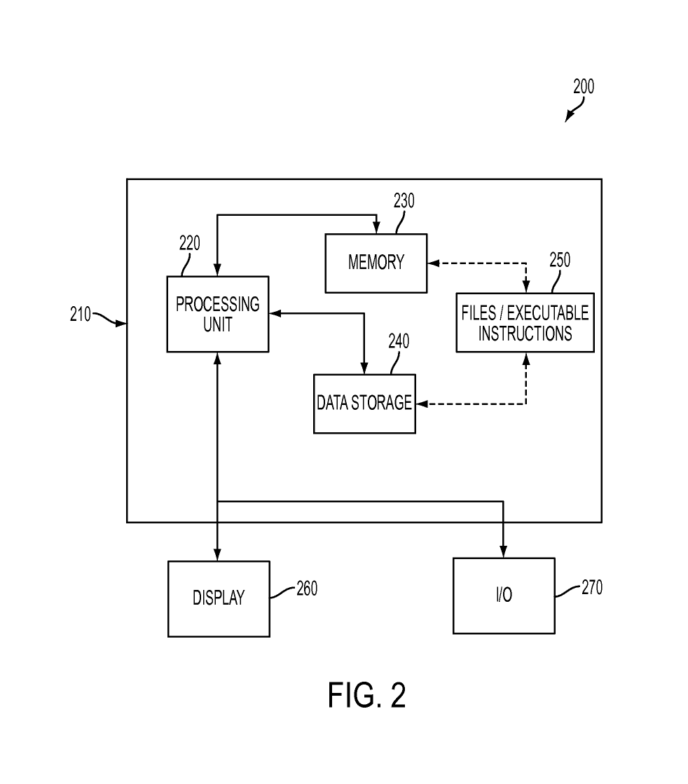

Referring now to FIG. 2, a general computing device system 200 is shown according to an exemplary embodiment of the present invention. The mobile computing device 110, the server 120, and the computing terminal 130 may operate according to the arrangement of the general computing device system 200. It will be understood that the mobile computing device 110, the server 120, and the computing terminal 130 may each include more elements than shown, however for sake of illustration, the minimum elements necessary for operation are provided. The general computing device system 200 may include a computing module 210 coupled to a display 260 and an I/O device 270. In some embodiments, the display 260 may include input means allowing a user to provide data input, for example, through touchscreen sensory. The I/O device 270 may be any peripheral device providing data input to the computing module 210 or providing an output from the processing unit 220. For example, the I/O device 270 may, in some embodiments be the printer 140 (FIG. 1). The computing module 210 may include a processing unit 220 in communication with the display 260 and the I/O device 270. The processing unit 220 may receive data from and provide executable commands to the display 260 and the I/O device 270. A memory module 230 and a data storage module 240 may be coupled to the processing unit 220. In some embodiments, software files and executable instructions 250 may be stored in the memory module 230 and/or the data storage module 240. The processing unit 220 may use the software files and executable instructions 250 to perform actions according to exemplary embodiments of the present invention. Some of the actions may be visible, for example, in the form of data shown on the display 260 or in the form of a print result sent to the I/O device 270. Other actions may provide invisible results, for example, changes to records stored in the data storage module 240.

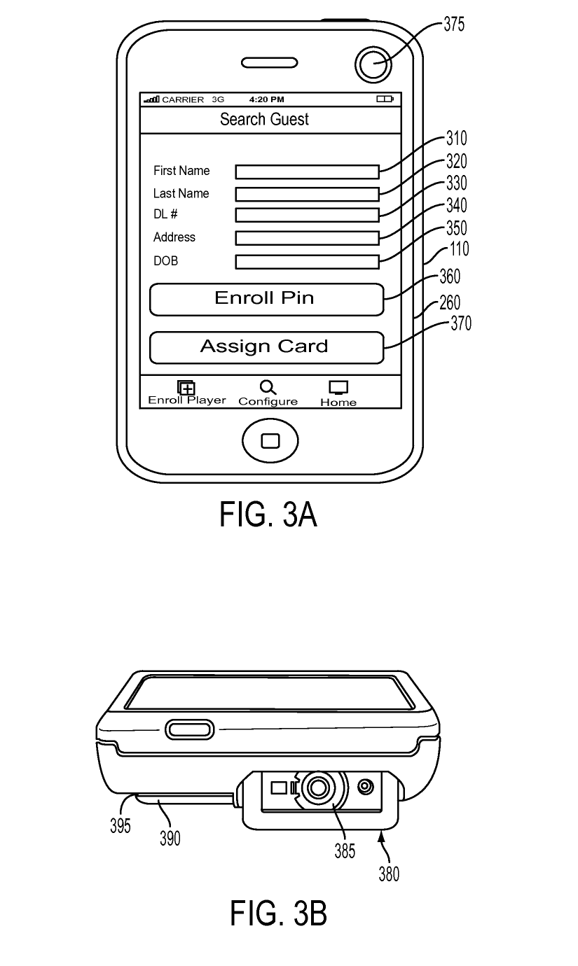

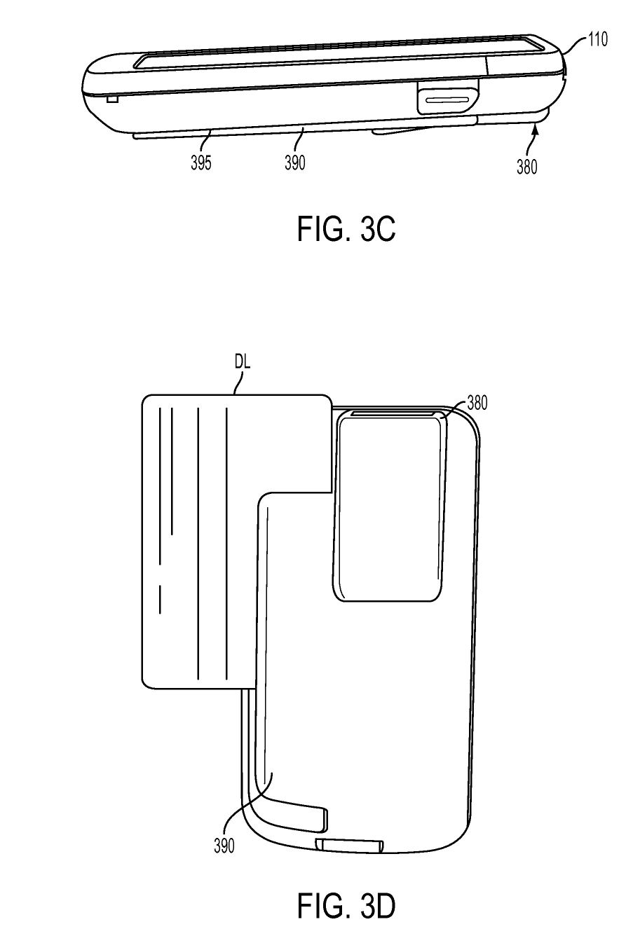

Referring now to FIGS. 3A-3D, a mobile computing device 110 is shown according to an exemplary embodiment of the present invention. The mobile computing device 110 may include a card reader 380. In an exemplary embodiment, the card reader 380 may be a sled type device. The card reader 380 may include a support panel 390 defining a gap 395 between the panel 390 and the mobile computing device 110. In other embodiments, the card reader 380 may be a bar code scanner or a quick response reader using, for example a sensor module 385. Information embedded (for example, in a magnetic stripe, quick response code, bar code, etc.) into a card DL (for example, a driver's license or financially linked card) is read by swiping the card DL across a detector (not shown) hidden by the panel 390 or by scanning the card DL in front of the sensor module 385. In some embodiments, the card reader 380 may be pluggable into the mobile computing device 110. In other embodiments, the card reader 380 may be integrated into the mobile computing device 110 via a software application that may extract information from a card via a camera 375 or other detector.

In operation, the user (for example, a company representative) may approach a player on the casino floor. The player may be in some instances engaged in one of the gaming options. The representative may inquire if the player is a member of the customer loyalty program and may offer to enroll the player on the spot. The display 260 may present a user interface to the representative via a software application where data corresponding to a read card may be shown. In an exemplary embodiment, the fields may be populated by automatically extracting information from, for example, a driver's license (not shown). The representative may ask for the player's driver's license and swipe the card DL through the card reader 380. The data extracted may be used to generate a membership account into the customer loyalty program. Exemplary data fields may include a person's first name 310, last name 320, driver's license number 330, address 340, and date of birth 360. In some embodiments, the user interface may allow a user to enter these fields manually, for example, when the magnetic stripe of a card DL is damaged or otherwise cannot be read. When the fields are populated, an enrollment feature 360 may be triggered. The information extracted from the driver's license may be associated with a membership account.

The system 100 may include an offline mode. In the offline mode, pre-printed membership cards may be pre-assigned with a membership number. When a customer's information is obtained, the information may be downloaded into the server 120 and associated with the membership card number. Thus, the customer may begin enjoying the benefits of membership as the membership card may be immediately used. For example, a company representative may travel to a remote location. Potential customers may be approached and enrolled using the pre-printed cards. The extracted information may be saved to the mobile computing device 110 until the company representative returns to a company location or reaches a network access point. Meanwhile, the enrolled customer may use the membership card and accumulate credit for actions corresponding to the loyalty program. An assign card command 370 may allow the customer representative to associate the members' account information with their respective membership cards at a later time. As may be appreciated, the player may be enrolled into the customer loyalty program and may begin earning credit while not having to leave their location to enroll.

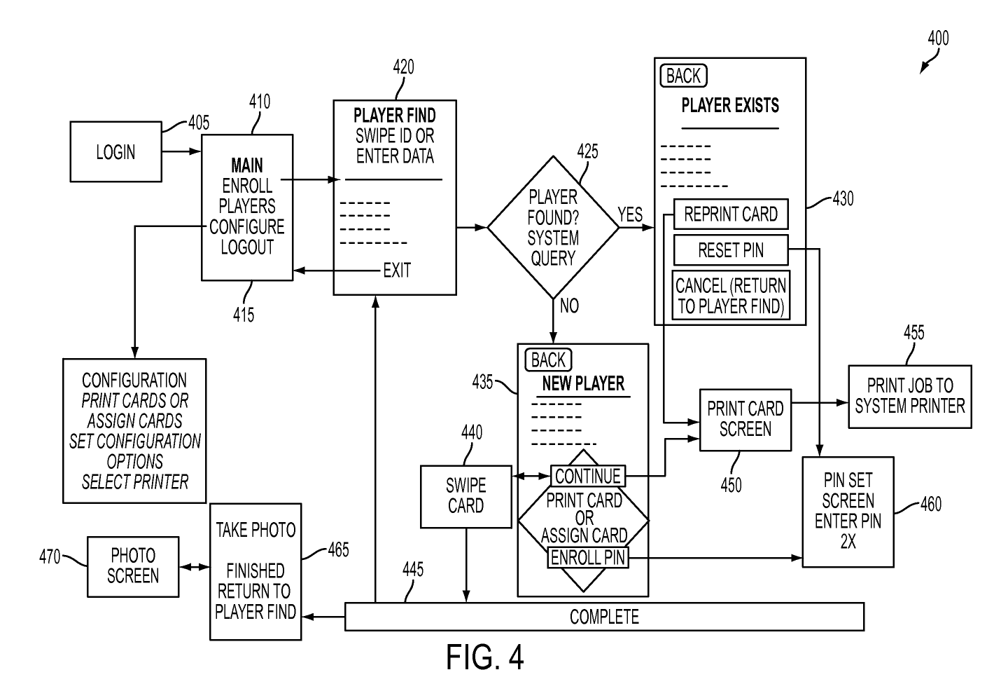

Referring now to FIG. 4, a method 400 of enrolling customers into the company loyalty program is shown according to an exemplary embodiment of the present invention. Unless otherwise noted, the actions in the blocks that are described in the following may be performed for example, by the processing unit 220 (FIG. 2). In block 405, a user may log in to the software application for enrolling customers into the loyalty program using the mobile computing device 110 (FIG. 1). In block 410, the user may be presented with a main menu with options. During an initial setup of the software application, the user may be presented in block 415 with a configuration screen allowing the user to set up functions for operation of the enrollment program. For example, the user may initialize whether the application will be printing out a new membership card for enrollees or will be assigning extracted customer information to a pre-assigned membership card. In block 420, the user may be presented with a screen to locate a customer by providing the person's information into the screen. The information may be extracted automatically or may be entered manually as described above. In block 420, a determination of whether the person's information as an account already exists in data storage.

In response to the customer already having a membership account, in block 430, the person's account information may be presented on screen. The user may be presented with options associated with the membership account. For example, the user may select an option to print a card where in block 450, the user is presented with a print option screen. The user may select a feature issuing a command in block 455 to print out a card corresponding to the membership account. Referring back to block 430, the user may also be presented with an option to set or reset a personal identification number (PIN) associated with the membership account. In block 460, the user may enter the new PIN and the membership account may be updated accordingly.

In response to the customer being a new member (where the person's information is not on file), the user in block 435 may be presented with an enrollment screen. A new member account may be generated using the person's information. In some embodiments, the user may use the camera 375 to, in block 465, photograph the customer on the spot and the photograph may be viewed and associated with the membership account in block 470. The user may in block 460, set up a new PIN for the membership account. The user may select the option to print out a new membership card in block 450 and the command to issue the new membership card may occur in block 455. The membership card may be retrieved from the printer 140 (FIG. 1) and presented to the player while the player remains at their station.

It should be understood, of course, that the foregoing relates to exemplary embodiments of the invention and that modifications may be made without departing from the spirit and scope of the invention as set forth in the following claims.

What is claimed is:

1. A computer program product for enrolling customers into a company loyalty program, the computer program product comprising a non-transitory computer readable storage medium having program code embodied therewith, the program code readable/executable by a processing unit to:
receive in a mobile computing device, a person's identification information from a driver's license; and
create, by the processing unit, a member account in the company loyalty program including the received information.

2. The computer program product of claim 1, the program code being readable/executable by the processing unit to read the person's identification information from the driver's license.

3. The computer program product of claim 2, wherein the person's identification information is read from a swipe of the driver's license through a card reader.

4. The computer program product of claim 2, wherein the person's identification information is read from a scan of the driver's license.

5. A system for enrolling a person into a company loyalty program, comprising:
a server;
data storage in the server including member accounts in the customer loyalty program; and
a mobile computing device configured to:
receive identification information from a driver's license,
determine whether the person is a member of the customer loyalty program based on the received identification information, and
associate the received identification information with a membership card corresponding to the customer loyalty program.

6. The system of claim 5, including a card reader coupled to the mobile computing device configured to read data stored on the driver's license.

7. The system of claim 5, wherein the mobile computing device is a mobile phone or a tablet.

8. The system of claim 5, wherein the mobile computing device is configured to photograph the person and send the photograph to a printer for printing onto the membership card.

9. The system of claim 5, wherein:
the server is configured to indicate to the mobile computing device that the person is not a member of the customer loyalty program, and
the mobile computing device is configured to create a member account for the person in response to receiving the indication from the server.

10. The system of claim 5, wherein the mobile computing device is configured to associate the received identification information with a pre-printed membership card while off-line from the server.
